(19) United States
(12) Patent Application Publication
(10) Pub. No.: US 2013/0132726 A1
(43) Pub. Date: May 23, 2013

(54) DIGITAL CERTIFICATION METHOD AND APPARATUS

(71) Applicants: Stephen M. Hitchen, Stocksfield (GB); Susan E. Morrow, Stocksfield (GB); James A.L. Porter, Swanage (GB); Gerard D. O'Brien, Surrey (GB)

(72) Inventors: Stephen M. Hitchen, Stocksfield (GB); Susan E. Morrow, Stocksfield (GB); James A.L. Porter, Swanage (GB); Gerard D. O'Brien, Surrey (GB)

(21) Appl. No.: 13/746,790

(22) Filed: Jan. 22, 2013

Related U.S. Application Data
(63) Continuation of application No. 12/182,461, filed on Jul. 30, 2008, now abandoned.
Application No. 12/182,461 is a continuation-in-part of application No. 11/881,849, filed on Jul. 30, 2007, now abandoned.

(51) Int. Cl. H04L 9/32

(52) U.S. Cl. CPC H04L 9/3263; H04L 9/3281
USPC 713/175

(57) ABSTRACT

A method for recording a document with authenticity certification information. The method includes receiving an indication from a user regarding their intention to accept and/or receive a proposed set of documentary content elements and presenting a visual display of the documentary content elements. The method further includes presenting and detecting an actuatable acknowledgment mechanism and receiving and transmitting account information to an account provider. The method also includes generating a digital certificate and key pairs from one or more items associated the account information.

### CROSS-REFERENCE TO RELATED APPLICATIONS

This patent application is a continuation-in-part application to U.S. patent application Ser. No. 11/881,849 filed in the USPTO on Jul. 30, 2007 by Hitchen et al., the entire contents of this application being incorporated herein by reference in its entirety.

### BACKGROUND

1. Technical Field

The present invention generally relates to the field of digital certification, and more particularly, to methods for certifying the authenticity of documents utilizing a multipurpose certification database and optionally associated hardware.

2. Description of the Related Art

Digital signatures are an established authentication vehicle used to validate the integrity of electronic documents. A digital signature, for example, may be utilized to validate the existence of a particular document during a specific period time. Many known digital signatures presently include a requirement that the endorser of the signature possess an individual digital certificate. These signatures, however, are of limited value as a majority of endorsers are not in possession of individual digital certificates. Additionally, problems associated with digital signatures include relatively cumbersome infrastructure implementations. Therefore, it would be desirable to overcome the disadvantages and drawbacks of the prior art with improved methods for the use of digital signatures.

### SUMMARY

According to aspects of the present disclosure, methods for recording a document with authenticity certification information are presented. The methods include receiving an indication that a user is prepared to accept and/or receive a proposed set of documentary content elements. The methods further include a visual display of the documentary content elements to the user. Additionally, the methods include presenting and detecting an actuatable acknowledgment mechanism.

A mechanism for receiving and transmitting specific account information to an account provider is provided. The methods include generating key pairs and a digital certificate from one or more items associated with the account information. Methods for retrieving, regenerating, and comparing hashes that are associated with the account information are further provided. The step of comparing the hashes includes presenting an indication to the user regarding the results of the comparison. Finally, the methods include an identity mechanism from which key pairs and digital certificates are generated.

### BRIEF DESCRIPTION THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 illustrates a flow diagram of an example of a method for recording a document with authenticity certification information, in accordance with the present disclosure;

FIG. 2 illustrates a flow diagram of an embodiment of the method of the present disclosure;

FIG. 3 illustrates a flow diagram of another embodiment of the method of the present disclosure;

FIG. 4 illustrates a flow diagram of an embodiment of the method, including the step of verification, according to the present disclosure;

FIG. 5 illustrates a flow diagram of yet another embodiment of the method of the present disclosure;

FIG. 6 illustrates a flow diagram of another embodiment of the method of the present disclosure;

FIG. 7 illustrates a flow diagram of an embodiment of the method, including the step of encrypting a document, according to the present disclosure;

FIG. 8 illustrates a flow diagram of another embodiment of the method of the present disclosure; and

FIG. 9 illustrates a flow diagram of yet another embodiment of the method of the present disclosure.

### DETAILED DESCRIPTION OF THE PREFERRED EMBODIMENTS

The following detailed description refers to the accompanying drawings. In the discussion that follows, the term “user” refers to an individual having, for example, an ATM, bank, check, credit, and/or debit card.

Most users presently possess one or more accounts, such as a credit or debit card account, the details of which are unique to that person. In accordance with the present disclosure, a user's existing account is utilized as an identification of its owner in a digital identity verification process or digital signature. This is achieved in the context of document authentication using the unique details of, by way of example, a credit card. The result of the methods of the present disclosure is to provide a more universally accessible and lower cost means of signing electronic documents. Specifically, it is envisioned that the methods are easily usable as a substitute for relatively cumbersome and expensive paper-based business procedures. Reference will now be made in detail to exemplary embodiments of the disclosure, which are illustrated in the accompanying figures.

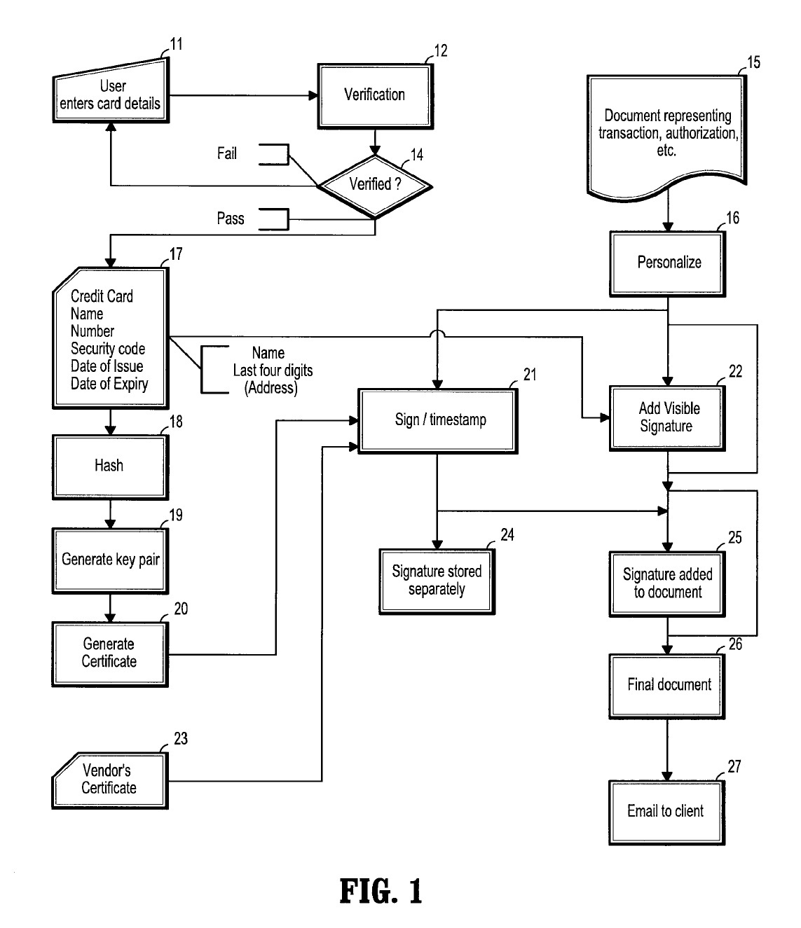

Referring now to FIG. 1, a flow diagram of an example of a method for recording a document with authenticity certification information is provided. The method includes an operator of a system, which may be any entity requiring an authenticated document that has a conventional digital certificate. The entity may be, but is not limited to, making a contract with a user, seeking a consent, and requiring an authenticated transfer of information. In addition, the user with whom the operator is dealing with may be required to have a credit card or the like.

At the beginning of the method, the user provides account information at step 11. The account information may consist of a sixteen digit account number, an expiration date, security verification numbers, and the name of the card issuer, such as Visa, MasterCard, Discover or American Express. In an exemplary embodiment of the present disclosure, the step of providing account information takes place at a personal computer connected to the Internet. The account information provided at step 11 is processed for verification at step 12.

It is contemplated that methods for verification at step 12 depend on the nature of the transaction involved. For example, the step of verification may take place when a user provides their account information. Verification may also take place by reference to a database which includes previous verifications in which the same credit card was used and validated. The result of the verification of step 12 is provided at decision step 14. At step 14, the user is given the opportunity to reenter their account information if the verification fails. Alternatively, if the account information is authenticated at decision step 14, the method proceeds to step 15.

At step 15, a document may be electronically generated by the system operator after the user's account information is validated. It is contemplated that the document may be, for example, a contract of sale, an acknowledgment of a receipt of a set of instructions, a product warning, and the like. Proceeding to step 16, the document generation may involve the personalization of an existing template document that includes information specific to the user.

The document generation of step 16 may be facilitated in whole or in part through the user information associated with the credit card. Proceeding now to step 17, a document with an embedded visible signature is presented to the user for signature, for example, by presentation of a screen showing the document, the credit card number, name, address, expiration date, card issuer, and presenting an “I Agree” hyperlink or icon. When the icon is selected, some or all of the account information provided at step 17 is provided to a secure hash algorithm (“SHA”), such as SHA-1, at step 18.

At step 18, the hash is provided to derive binary data of some fixed length. A secure hash algorithm refers to a number of functions that share a common basis, all of which produce a fixed size, unique, digital fingerprint from digital data. The difference between various SHA algorithms is the size of the fingerprint produced, with larger sizes increasing the probability that the fingerprint will be unique for a given set of data. In a preferred embodiment of the present disclosure, the version of SHA used in the digital certificates and signing is SHA-1, which produces a fingerprint of 160 bits. The method at step 18 subsequently proceeds to step 19 upon generating the hash.

At step 19, the hash is used to seed a pseudo-random number generator to generate prime numbers that form the basis for a key pair. For example, if a common RSA algorithm is used, the pseudo random number generator may create the primes p and q as the basis of the keys for this algorithm. It is contemplated that key pairs for algorithms other than RSA, such as, an elliptic curve, may also be generated from the hash to further extend the application of the present disclosure. It is further contemplated that key pairs may be, but are not limited to, asymmetric, AES, DES, and MAC algorithms. It is further contemplated that a symmetrical key pair may be generated.

It is contemplated that personal digital certificates can be instantaneously generated with consistent key pairs without the need for storage or transportation as normally associated with prior art digital certificates. In one embodiment, it is envisioned that a user can regenerate their digital certificate and produce conventional digital signatures regardless of their location. The key pairs are subsequently used to create a digital certificate at step 20.

At step 20, the digital certificate incorporates account information, such as the name of the user and the last four digits of their credit card. The account information may be provided in displayable fields on the digital certificate to facilitate the identification of the card used. The generated certificate of step 20 is subsequently used to provide a signature at step 21. The signature incorporates the generated certificate to facilitate later verification of the signature.

To increase the non-repudiation of the generated certificate, the certificate may be time stamped at step 21. The step of providing a time stamp may be performed by sending a hash of the signature or document to a certified time stamp provider. The time-stamp provider may digitally sign the hash along with the current date and time from a reliable time source and return the signed information as a time stamp. It is envisioned that the time stamp can be used to prove the time of the signature and use of the credit card details. The time stamp may be subsequently incorporated into the signature in step 21. Additionally, to further strengthen the signature, it may also be countersigned by the vendor's digital certificate at step 23. Following generation and use of the RSA key pair and digital certificate, both items can be destroyed. Step 21 proceeds to step 22.

Time-stamping standards in the form of Request For Comments (“RFC”) are provided by the Internet Engineering Task Force (“IETF”). RFCs such as RFC 3161 and RFC 2898 may be utilized in a preferred embodiment of the present disclosure. The substance of RFC protocols and IETF standards are incorporated herein by reference.

At step 22, a visible representation of the signature may optionally be incorporated into the document. The visible signature may include, for example, the last four digits of the sixteen digit credit card number. Additionally, the card holder's name and address may be placed in the visible signature field. The method at step 22 proceeds to step 25. The completed digital signature may be stored separate from the document, for example, in a database at step 24. More conveniently, the signature may be stored in the document itself at step 25 to produce the final document at step 26. It is contemplated that either the document or an image of the document of step 26 may be sent by e-mail to the user for his records.

It is contemplated that in accordance with the present invention, the account information, such as the name of the user, the credit card number, credit card type, security code, date of issue, date of expiration, and or other data may be gathered over the telephone to allow for the use of the authentication and signature verification system in off-line applications. It is further contemplated that authentication may include signature verification, document authentication, agreement indication, and other similar functions, and that any one of these implementations, when illustrated by a particular example, may be implemented in that particular example, as generally taught herein.

The credit card hash, the card's last four digits, user name and address and other information may also be added as signature attributes to facilitate electronic verification of the document. Other information, which may be included with the signature, may include a document description or identification number to facilitate searching, indexing, and for providing a record. The same is of particular value if the signature is stored separately from the document. Such separate storage could facilitate rapid searching and verification with respect to documents, where the person making the inquiry has only limited or paper information.

As will be understood from the present disclosure, the method may be used either on-line or off-line. In either case, only the system operator requires the installation of software. The software required for off-line use is substantially identical to that required for online use, except that online use requires the additional installation of software for interfacing with input from the user, for example, over the Internet. Conversely, off-line usage requires the system operator to install user function components to allow the input of user generated information into the system as it is received, for example, over the telephone from the user, at a keyboard, or a screen of a merchant.

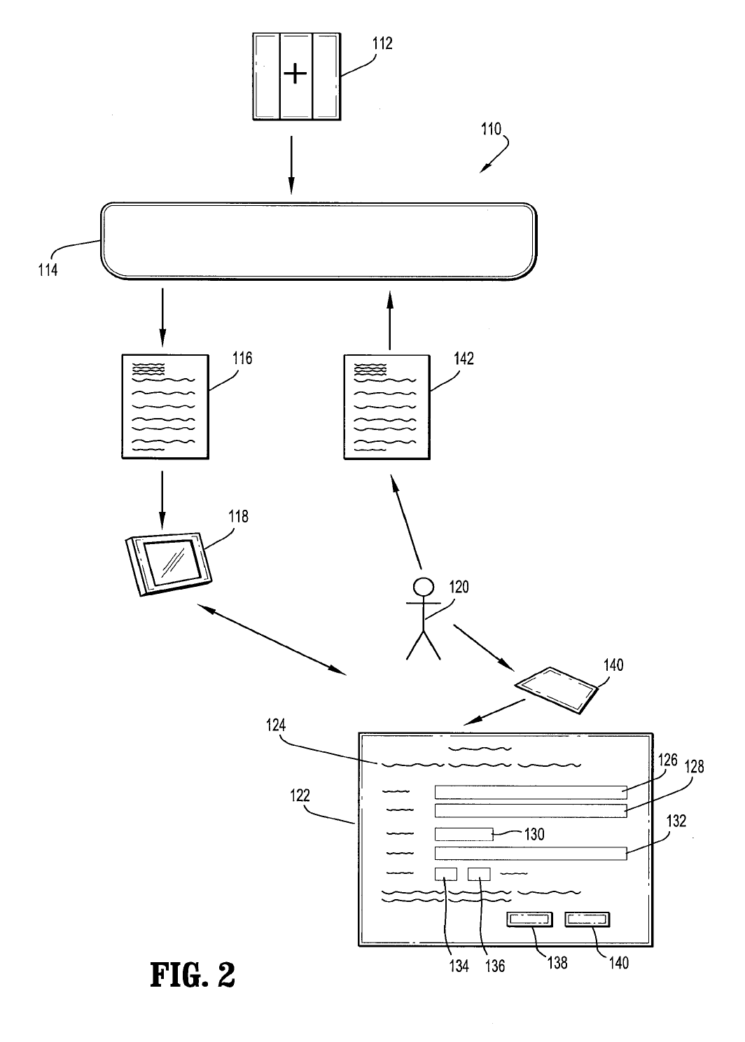

Referring now to FIG. 2, an example of an exemplary method according to the present disclosure is provided. A method 110 is provided for authenticating the documentation of a patient's consent given to a hospital 112. Hospital 112 includes a document system 114, which is used to generate documents, such as a blank operation consent form 116. The blank operation consent form 116 may be displayed on a liquid crystal display (“LCD”) screen 118 for presentation to a patient 120 in a hospital receiving room or a doctor's office.

A form 122, which includes consent agreement terms 124, typically consists of a field 126 for the entry of the user's name, a field 128 for the entry user's address, a field 130 for the selection of the credit card issuer, a field 132 for the entry of a sixteen digit credit card number, a field 134 for the entry of a card expiration date, a field 136 for the entry of the year of expiration of the credit card, an icon 138 for the indication of agreement, and an icon 140 for a declination of agreement.

Document 122 is presented to the user 120 on the screen 118. In this example, the user 120 is in a hospital at a special word processing station. The user 120 subsequently enters the data from their credit card, such as, a Visa credit card 140. Upon the user clicking the “I agree” icon 138, the credit card details are used to generate a digital certificate. The digital certificate is used to digitally sign the document 122. Optionally the signature may be time stamped and countersigned. The signed version 142 of document 122 is sent to the hospital's document system 114 for storage.

It is contemplated that the digital certificate data associated with the charge may be encrypted in the document before it is stored in the document system 114. It is further contemplated that the hospital's document system may serve as an input and database for document authentication and the verification functions.

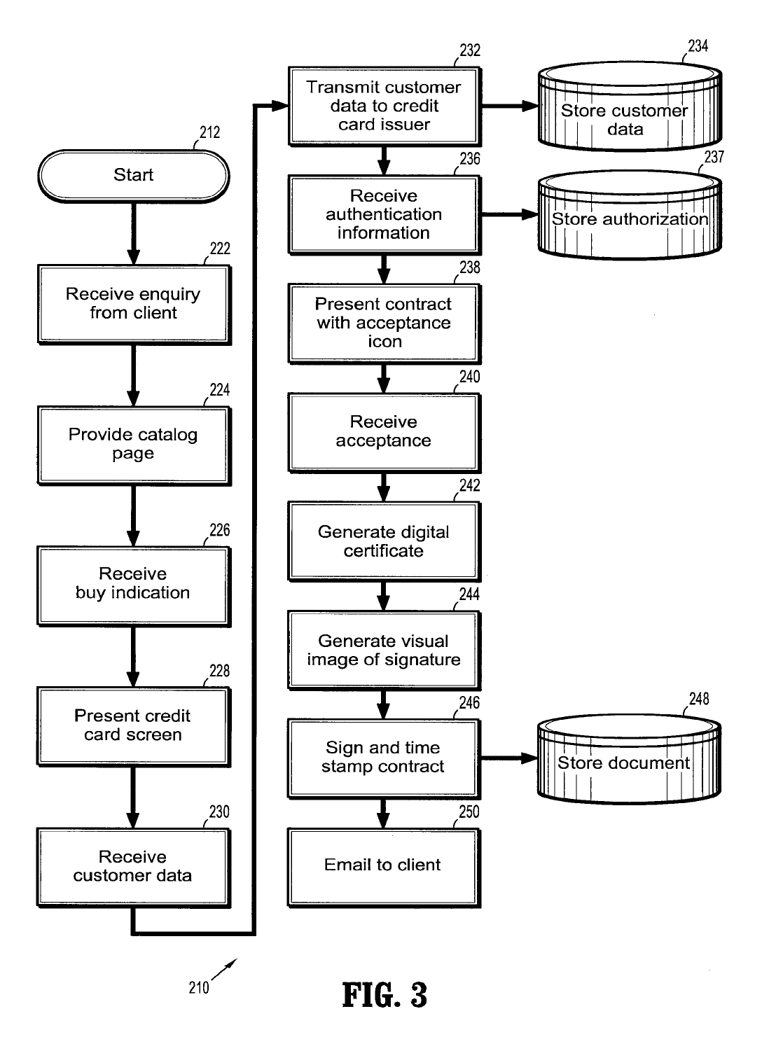

Referring now to FIG. 3, another example of an exemplary method according to the present disclosure is provided. The method 210 is illustrated in the context of a purchase in which the terms of purchase require a user's signature in order to form an agreement.

The method 210 of the present disclosure is implemented through the use of a website typically used for the transaction of business over the Internet. The implementation of the method 210 begins with the activation of the website at step 212. Upon receipt of an inquiry from a user at step 222, the user is provided with various catalog pages and opportunities to purchase goods at step 224. For example, upon a user's indication of their desire to purchase goods, perhaps by clicking an “add to shopping cart” icon at step 226, the user is provided with an input screen at step 228 to provide customer data at step 230.

In one embodiment of the present disclosure, the user may have a credit card reader associated with their computer. The user may swipe the card to fill in the fields in the form presented on the input screen at step 228. The method of step 230 proceeds to step 232. At step 232, the customer data provided in step 230 is transmitted to the credit card issuer. Additionally, the customer data may be stored in a data storage unit for later use. Step 232 proceeds to step 236.

At step 236, the credit card issuer sends an electronic message authorizing the charge and indicates its acceptance of the customer data. The electronic message is subsequently stored at step 237. At step 238, a contract screen displaying the terms of the contract and an acceptance icon is presented to the customer. Upon clicking the “I accept” icon, the user's acceptance is transmitted to the system operator at step 240. Step 240 proceeds to step 242.

At step 242, the system operator generates a digital certificate. The system, at step 244, generates a visual image of the signature, which contains the customer name and last four digits of their credit card number. The visual image is placed in the contract and the system operator uses the digital certificate to sign the contract at step 246. It is contemplated that the signature may also be time-stamped upon signing the contract. Step 246 proceeds to step 248. The signed contract is stored at step 248 and a copy of the contract is emailed optionally to the user at step 250.

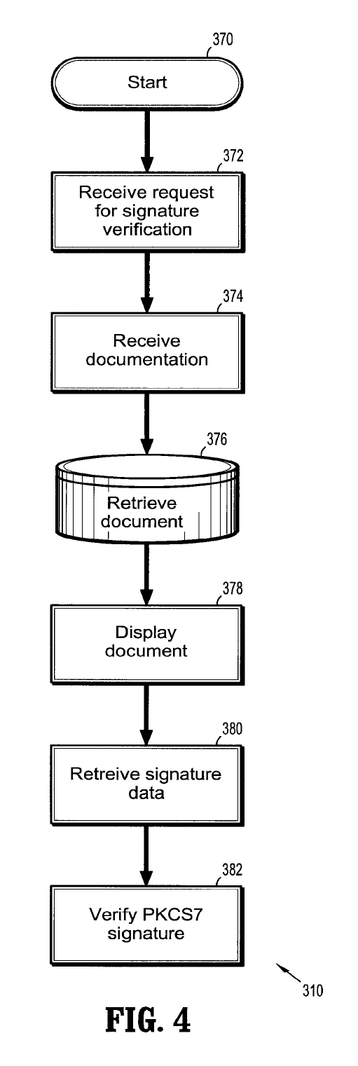

Referring now to FIG. 4, an example of an embodiment of a method according to the present disclosure is provided. The method 310 illustrates the step of verifying a signature on a document. At step 370, the verification process begins with the receipt of a request for signature verification at step 372. A request to receive the signed document is subsequently provided at step 374 and the document is retrieved at step 376. Step 376 proceeds to step 378. At step 378, the document is displayed to the user making the inquiry. Finally, the system retrieves the digital signature from the document and verifies both the signature and the time-stamp in steps 380 and 382, respectively.

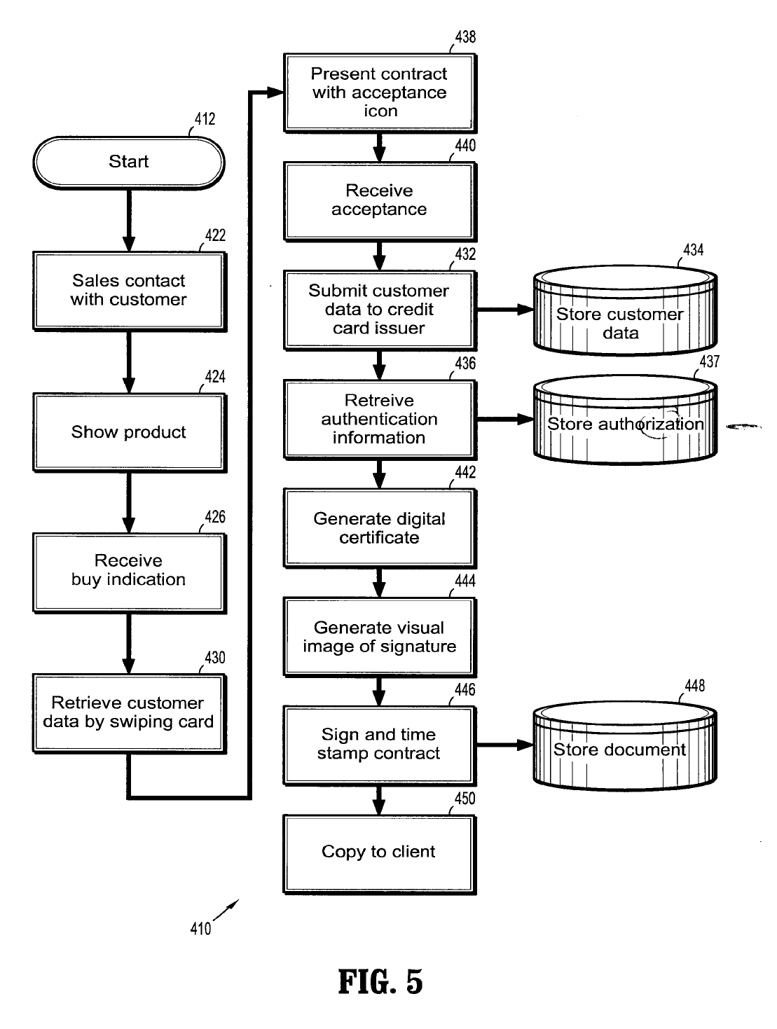

Referring now to FIG. 5, another example of an exemplary method according to the present disclosure is provided. The method 410 is illustrated in the context of a purchase in a bricks and mortar context, for example, at a retail location operated by a merchant.

Method 410 begins at step 412 with the receipt of a customer at a retail location. At step 422, a sales contact is made with the customer. Proceeding to step 424, the customer is shown a product and they provide an indication to buy a product to the sales clerk at step 426. Step 426 proceeds to step 430.

At step 430, a sales clerk swipes the credit or debit card of the customer. The customer is presented with a contract, for example, on the screen of a personal computer at step 438. The screen also includes the terms of the contract and/or any other information which the merchant wishes the customer to accept and agree to. The user's acceptance is made by clicking on a suitable icon at step 440. Step 440 proceeds to step 432.

At step 432, data generated by the card swipe of step 430 is transmitted to the credit card issuer. The data of step 432 is subsequently stored at step 434. A return data stream is then received at step 436 and stored at step 437. Step 436 proceeds to step 442.

At step 442, a digital certificate is generated based upon the return data stream of step 436. Step 442 proceeds to step 444. A visual image of the signature is generated at step 444 and the digital signature from step 442 is used to sign the contract at step 446. The contract is also time stamped at step 446. Step 446 proceeds to step 448. At step 448, the signed contract is stored in a storage medium and a copy of the signed contract is provided to the user at step 450.

A further extension of the present disclosure is the generation of keys pairs for encryption. An encryption key may be, for example, an asymmetrical or symmetrical, AES or DES key that is derived from the credit card data using a method such as that described as RFC 2898. Alternatively, the encryption key may be derived through a hash algorithm, the output of which can be used directly, re-hashed or otherwise transformed. Conversely, the encryption key may be derived by putting the card data into a pseudo random number generator.

It is contemplated that the credit card data may be transformed to binary data, which is used as an encryption key. The step of transforming the data to binary data avoids the direct use of the card data as the key. It is further contemplated that the derived key can be used to encrypt a document or message intended only to be decrypted by an authorized credit card user. The recipient of the message or document uses their credit card to regenerate the encryption key and decrypt the message.

It is envisioned that the contemplated methods of encryptions could be used by banks and other card issuers for secure communication with their customers. In one embodiment, the document or message from the bank is encrypted using the method set forth above. Upon receipt by the customer of the encrypted message, the message is decrypted and read. Additionally, the document may be edited by the customer, encrypted using the above scheme, and returned to the bank for decryption using the customer's card details. It is further envisioned that upon using an encryption scheme, the storage of credit card details on mobile devices, such as cell phones can facilitate secure messaging between the bank and the customer via their mobile device. It is contemplated that the encryption scheme may utilize an encryption and decryption software on the mobile devices.

In one embodiment of the present disclosure, the digital certificate and corresponding key pairs may be used for encryption applications through the use of an established public key encryption cipher, such as RSA. The methods for signing documents and encrypting documents can also be combined to produce signed and encrypted documents.

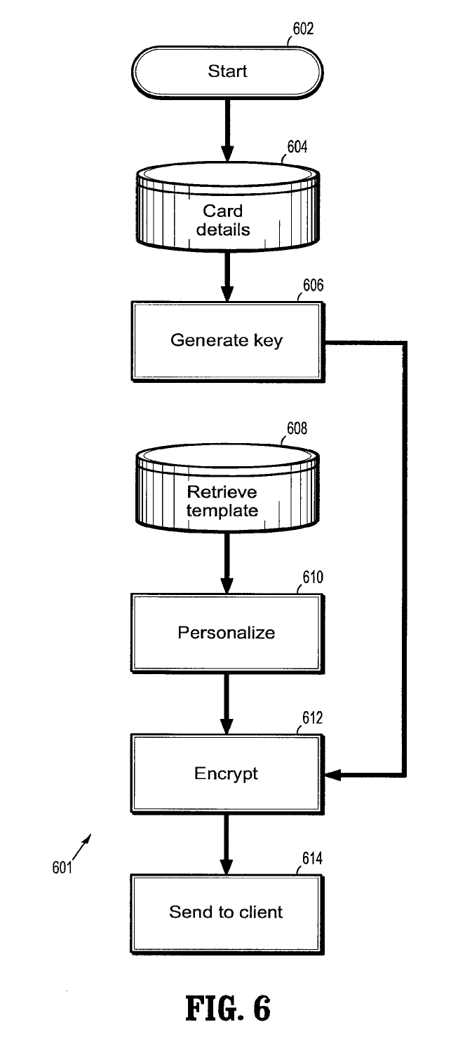

Referring now to FIG. 6, another example of an exemplary method according to the present disclosure is provided. The method 601 is illustrated in the context of bank communicating a secure form to a user, such as a mortgage agreement form.

The method begins at step 602 with the bank retrieving the user's credit card details from its database. At step 604, the bank uses the credit card details to generate an encryption key such as, for example, a 256 bit AES symmetric key. The encryption key may be created by taking portions of the credit card details and translating the data through a hash in step 606. Step 606 proceeds to step 608.

At step 608, a template document is taken from the bank database and is personalized for the user in step 610. At step 610, the document is prepared and encrypted at step 612 with the key generated in step 606. It is contemplated that the encryption key can be discarded after step 612. Finally, the encrypted document is sent to the user by email in step 614.

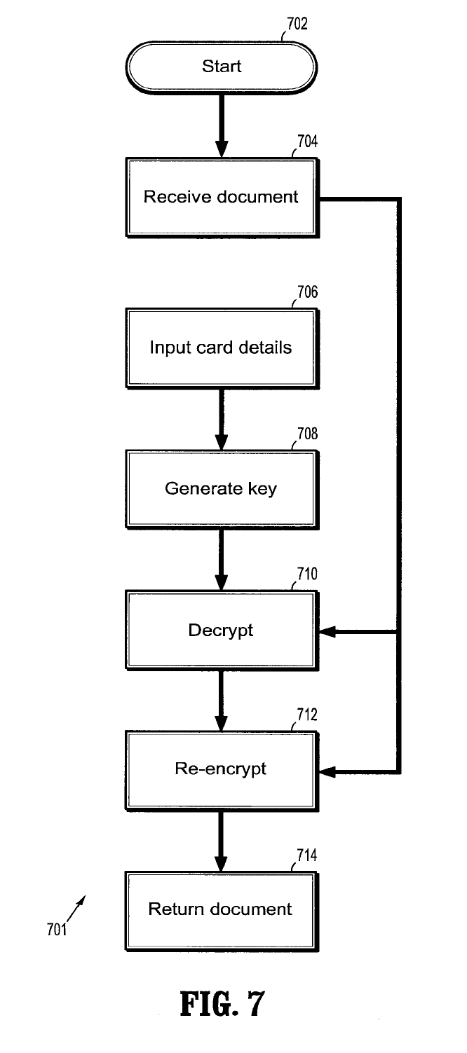

Referring now to FIG. 7, another example of an exemplary method according to the present disclosure is provided. The method 701 is illustrated in the context of demonstrating the methods in which an encrypted document may be used by a bank.

The method begins at step 702 with the user receiving a document by email in step 704. Step 704 proceeds to step 706. At step 706, the user inputs their credit card details into a program that generates an encryption key at step 708. Step 708 proceeds to step 710.

At step 710, the encryption key is used to decrypt the document of step 704. If the document requires user edits, the user may make appropriate changes and subsequently re-encrypt the document at step 712. Step 712 proceeds to step 714. At step 714, the document is returned to the bank. It is contemplated that an external card swiping device could be programmed to carry out these steps.

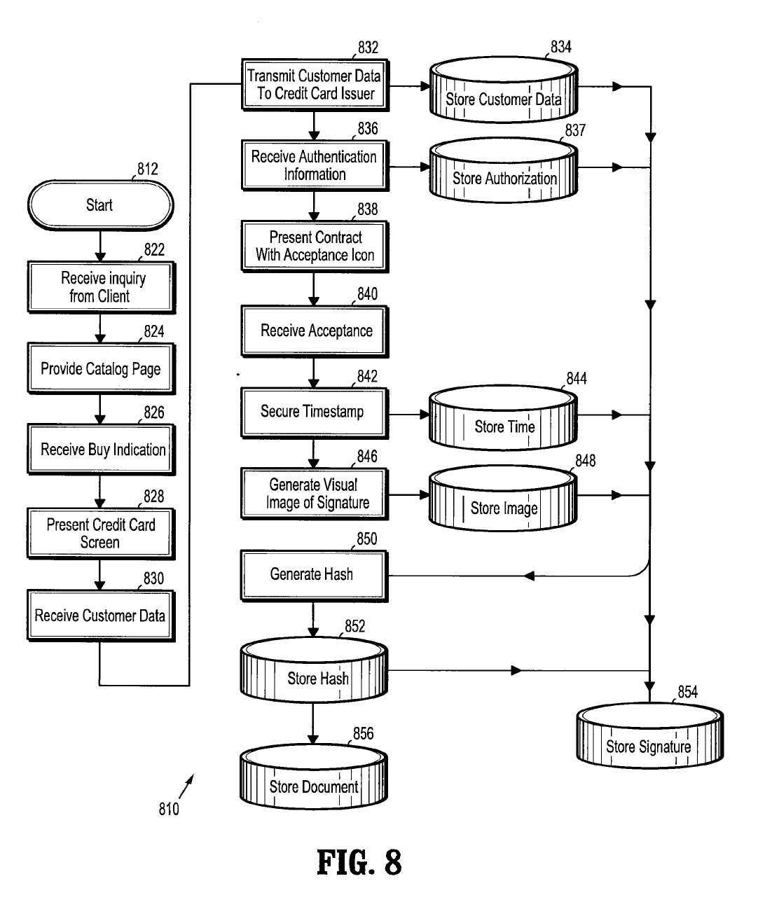

Referring now to FIG. 8, another example of an exemplary method according to the present disclosure is provided. The method 810 is illustrated in the context of a purchase in which the terms of purchase require a user's signature in order to form an agreement.

In one embodiment, the method of the present disclosure is implemented through the use of a website typically used for the transaction of business over the Internet. The implementation of the method 810 begins with the activation of the website at step 812. Step 812 proceeds to step 822.

At step 822, the user is provided with various catalog pages and opportunities to purchase goods at step 824. Upon the indication of a user's desire to purchase by clicking an “add to shopping cart” icon at step 826, the user is provided with an input screen at step 828 to receive customer data at step 830. It is contemplated that as an alternative to filling in the contents of screen 828, the customer may have a card reader associated with the customer's computer and may swipe their card to fill in the fields. Step 830 proceeds to step 832.

At step 832, the customer data is transmitted to the credit card issuer. The data may be stored in a storage device at step 834. Proceeding to step 836, the credit card issuer sends an electronic message authorizing the charge and indicating his acceptance. The electronic message indicating an authorization and acceptance may be stored in a storage device at 837. Step 836 proceeds to step 838.

At step 838, a contract screen displaying the terms of the contract and an acceptance icon is sent to the customer. Upon clicking the “I accept” icon, the user's acceptance is transmitted to the system operator at step 840. Proceeding to step 842, the system operator may secure a timestamp to the document from a certified timestamp provider. The time stamp may be stored at step 844 together with the timestamp provider information which accompanied the same. Step 842 proceeds to step 846.

At step 846, the system generates a visual image of the signature of the customer and the same is stored at step 848. Now proceeding to step 850, the system receives the data stored at steps 834, 837, 844 and 848 and generates a hash. The hash is subsequently stored at step 854 together with the data stored at steps 834, 837, 844 and 848. It is contemplated that the signature data stored at step 854 may be encrypted when the agreement document is stored at 856. It is further contemplated that an image of the agreement document with the signature generated at step 846 may be sent to the user for their records.

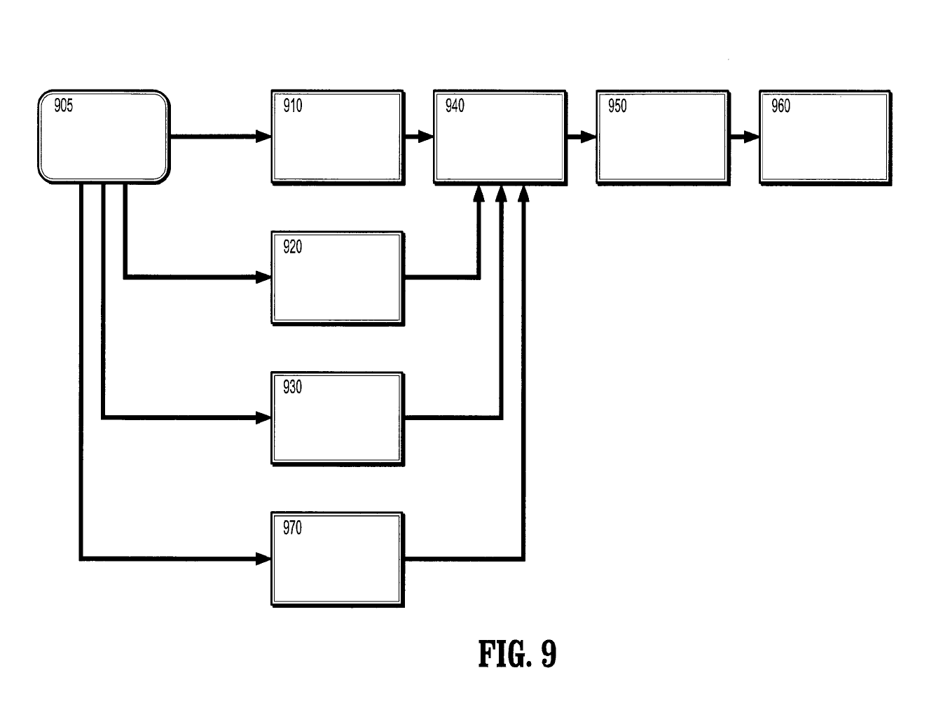

Referring now to FIG. 9, an example of another embodiment of a method according to the present disclosure is provided. The method is illustrated in the context of a purchase in which a conventional digital certificate is unavailable.

The method beings at step 905, in which the user accesses a form through, for example, a web browser program having software required for key generation. At step 905, when the user has filled in the form and elects to sign it, a key pair is generated from user supplied data at step 940.

In one embodiment, the key pair may be entered directly by the user at step 910, taken from a form that the user has filled in at step 920, or supplied by the system from login information or other stored personal information in step 930. The method of step 940 proceeds to step 950. At step 950, the key pair is used to create a standard digital certificate, such as an X509 certificate. The certificate may be used to sign the required data and subsequently produces a standard digital signature at step 960.

It is contemplated that the method may apply to the use of digital identities, such as, for example Microsoft Corporation's CardSpace or OpenID. It is envisioned that when the user elects to sign a document or form at step 905, they may be asked to provide a digital identity card at step 970. Details from the identity card, such as an email address, home address, or social security number are then input into the key generation process at 940. The digital certificate is generated at step 950 and the digital signature is produced at step 960. It is further contemplated that the method of digital signing can be used for controlling access to files documents and other digital resources based on the generation of the key pair and its use for encryption and decryption.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A method for recording a document with authenticity certification information, comprising:
receiving an indication that a user is prepared to indicate acceptance and/or receipt of a proposed set of documentary content elements;
presenting a visual display of the documentary content elements;
presenting an actuatable acknowledgment mechanism;
receiving an account information;
detecting the actuation of the actuatable acknowledgment mechanism;
transmitting the account information to an account provider;
generating key pairs from one or more items associated the account information; and
generating a digital certificate from one or more items associated with the account information.

2. The method for recording a document with authenticity certification information of claim 1, wherein the documentary content elements is a contract evidencing an offer and an acceptance.

3. The method for recording a document with authenticity certification information of claim 1, wherein the items include any one or more of a date, a time, an information sent to the account provider, an information received from the account provider, an information sent to a certified timestamp operator, and an information received from the certified timestamp operator.

4. The method for recording a document with authenticity certification information of claim 1, wherein the step of actuation of the actuatable mechanism results in transmitting the account information, including a charge to a debit and credit card.

5. The method for recording a document with authenticity certification information of claim 1, wherein the one or more steps of the method are implemented online through a network.

6. The method for recording a document with authenticity certification information of claim 5, wherein the network is the Internet.

7. The method for recording a document with authenticity certification information of claim 5, wherein the network is a telephony network.

8. The method for recording a document with authenticity certification information of claim 1, wherein the one or more steps of the method are implemented off-line.

9. The method for recording a document with authenticity certification information of claim 1, wherein the documentary content elements are coupled with a visual representation of a signature and provided to the user.

10. The method for recording a document with authenticity certification information of claim 9, wherein the signature is embedded in electronic documents provided to the user.

11. The method for recording a document with authenticity certification information of claim 1, wherein the step of generating the digital certificate is used to digitally sign electronic documents.

12. The method for recording a document with authenticity certification information of claim 1, wherein the step of generating key pairs includes a symmetrical encryption key pair.

13. The method for recording a document with authenticity certification information of claim 1, wherein the step of generating key pairs includes asymmetrical encryption key pairs.

14. A method for recording a document with authenticity certification information, comprising:
receiving an indication that a user is prepared to indicate acceptance and/or receipt of a proposed set of documentary content elements;
presenting a visual display of the documentary content elements;
presenting an actuatable acknowledgment mechanism;
presenting a mechanism for receiving an account information;
detecting the actuation of the actuatable acknowledgment mechanism;
transmitting the account information to an account provider;
generating key pairs from one or more items associated with the account information;
generating a digital certificate from one or more items associated with the account information;
retrieving a hash associated with the items;
regenerating the hash associated with the items;
comparing the regenerated hash to the retrieved hash; and
presenting an indication of verification that the regenerated hash and the retrieved hash are the same.

15. The method for recording a document with authenticity certification information of claim 14, wherein the step of regenerating the hash is performed by an algorithm.

16. The method for recording a document with authenticity certification information of claim 14, wherein the step of generating key pairs includes a symmetrical encryption key pair.

17. The method for recording a document with authenticity certification information of claim 14, wherein the step of generating key pairs includes asymmetrical encryption key pairs.

18. A method for recording a document with authenticity certification information, comprising:
receiving an indication that a user is prepared to indicate acceptance and/or receipt of a proposed set of documentary content elements;
presenting a visual display of the documentary content elements;
presenting an actuatable acknowledgment mechanism;
receiving an account information;
detecting the actuation of the actuatable acknowledgment mechanism;
transmitting the account information to an account provider;
presenting an identity mechanism;
generating key pairs from one or more items associated the identity mechanism; and
generating a digital certificate from one or more items associated with the identity mechanism.

19. The method for recording a document with authenticity certification information of claim 18, wherein the step of presenting an identity mechanism includes a digital identity.

20. The method for recording a document with authenticity certification information of claim 18, wherein the step of generating key pairs includes a symmetrical encryption key pair.

21. The method for recording a document with authenticity certification information of claim 18, wherein the step of generating key pairs includes asymmetrical encryption key pairs.
